(19) United States
(12) Patent Application Publication
(10) Pub. No.: US 2018/0039463 A1
(43) Pub. Date: Feb. 8, 2018

(54) SYSTEMS AND METHODS FOR SCHEDULING PRINT JOBS

(71) Applicant: XEROX CORPORATION, Norwalk, CT (US)

(72) Inventor: Chandrasekhar Appagunta, Nellore (IN)

(21) Appl. No.: 15/230,522

(22) Filed: Aug. 8, 2016

(51) Int. Cl. G06F 3/12

(52) U.S. Cl. CPC G06F 3/1263; G06F 3/1204; G06F 3/1268; G06F 3/1274

(57) ABSTRACT

The present disclosure discloses methods and systems for scheduling a print job received at a printer gateway for submission to a print server, the print job being received from a client device and stored in a print spooling directory. The method includes generating a token corresponding to the stored job, adding the token to a first list, determining if a print queue specified in the token is enabled at the print server, when the printer gateway is enabled, submitting the stored job to the print server, when each of the printer gateway and corresponding print queue are enabled at the print server, and moving the token from the first list to the second list when at least one of the printer gateway and corresponding print queue are not enabled at the print server.

### TECHNICAL FIELD

The presently disclosed embodiments are directed to network printing, and more particularly to systems and methods for scheduling print jobs received at a printer gateway for submission to a print server.

### BACKGROUND

Network printing includes printing documents by multiple users of a communication network without using a direct connection or cable between computing devices and printers. The Line Printer Remote (LPR) protocol serves as a system that allows such computing devices and printers to communicate and function with each other in the communication network.

The LPR protocol allows multiple print queues at the remote print server for receiving and managing print jobs from multiple client devices. Further, the LPR gateway enables the print requests to be temporarily stored in a print spooling directory before submitting them to the remote print server for printing.

However, with existing LPD server and gateways, the user faces problems of premature loss of print jobs, where the job submission may fail and the job may be deleted from the print spooling directory without completion. The job submission may fail if a print queue specified in a print job is not enabled at the LPD server, and/or if the LPR gateway is not enabled at the LPD server, and/or due to the network transfer failure, First in First Out (FIFO) failure, etc. When a print job is prematurely deleted from the print spooling directory without completion, the user may have to re-submit the print job, which is quite time consuming and cumbersome for them. In a further example, when the user runs a script with LPR commands to submit print jobs through the LPR gateway, for example, 100 jobs from different queues, and some job submissions fail, then the user may have to collect the details of the jobs and queues which they submitted, change the script once again, change the settings and re-run the script to submit the job. The whole process of re-submission of jobs is quite tiring and cumbersome for the user.

It may therefore be advantageous to provide methods and systems for scheduling the print jobs submitted to the print server through a printer gateway such as LPR gateway.

### SUMMARY

The present disclosure discloses methods and systems for scheduling one or more print jobs received at a printer gateway for submission to a print server. In an embodiment, a method for scheduling one or more print jobs at a printer gateway in a real-time, for submission to a print server is disclosed. The print job is received from a client device and stored in a print spooling directory, where the client device executes an application of the print server to display a Graphical User Interface (GUI) of the print server. The method includes generating a token corresponding to the stored job, the token comprising one or more particulars of the stored job. The token is added to a first list at the printer gateway. Then it is checked if the printer gateway is enabled at the print server, and the token is moved from the first list to a second list at the printer gateway, when the printer gateway is not enabled at the print server. The method further includes checking if a print queue specified in the token of the first list is enabled at the print server, when the printer gateway is enabled at the print server. The token is moved from the first list to the second list, when corresponding print queue is not enabled at the print server, and corresponding stored job is submitted to the print server, when corresponding print queue is enabled at the print server.

In another embodiment, a system for scheduling one or more print jobs at a printer gateway for submission to a print server is disclosed. The system includes a print spooling directory configured to store a print job received from a client device, and a print gateway controller. The print gateway controller is configured to generate a token corresponding to the stored job. The token is added to a first list at the printer gateway. The token is moved from the first list to a second list at the printer gateway, when the printer gateway is not enabled at the print server. It is checked if a print queue specified in the token is enabled at the print server, when the printer gateway is enabled. The token is moved from the first list to the second list when corresponding print queue is not enabled at the print server. The stored job is submitted to the print server, when corresponding print queue is enabled at the print server.

In yet another embodiment, a non-transitory computer-readable medium storing a computer-readable instructions is disclosed that when executed by a print gateway controller of a system for scheduling one or more print jobs, the non-transitory computer-readable medium comprising instructions for storing a print job received from a client device in a print spooling directory; generating a token corresponding to the stored job, the token comprising one or more particulars of the stored job; adding the token to a first list at the printer gateway; checking if the printer gateway is enabled at the print server; moving the token to a second list, when the printer gateway is not enabled at the print server; checking if a print queue specified in the token is enabled at the print server, when the printer gateway is enabled; moving the token from the first list to the second list when corresponding print queue is not enabled at the print server; and submitting corresponding stored job to the print server, when corresponding print queue is enabled at the print server.

Other and further aspects and features of the disclosure will be evident from reading the following detailed description of the embodiments, which are intended to illustrate, not limit, the present disclosure.

### BRIEF DESCRIPTION OF THE DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

FIG. 1 is a block diagram illustrating a system environment in which various disclosed embodiments can be practiced.

FIG. 2 is a block diagram illustrating a system for scheduling print jobs received at a printer gateway, in accordance with an embodiment.

FIG. 3 is a flowchart illustrating a method for scheduling a print job received at the printer gateway, in accordance with an embodiment.

FIGS. 4A and 4B are flowcharts illustrating a detailed method for scheduling a print job received at the printer gateway, in accordance with an embodiment.

### DESCRIPTION

A few inventive aspects of the disclosed embodiments are explained in detail below with reference to the various figures. Embodiments are described to illustrate the disclosed subject matter, not to limit its scope, which is defined by the claims. Those of ordinary skill in the art will recognize a number of equivalent variations of the various features provided in the description that follows.

### Non-Limiting Definitions

Definitions of one or more terms that will be used in this disclosure are described below without limitations. For a person skilled in the art, it is understood that the definitions are provided just for the sake of clarity, and are intended to include more examples than just provided below

A “client device” may refer to a device that includes a processor/microcontroller and/or any other electronic component, or a device or a system that performs one or more operations according to one or more programming instructions. Examples of the client device include, but are not limited to, a desktop computer, a laptop, a personal digital assistant (PDA), a mobile phone, a smart-phone, a tablet computer, and the like.

A “LPR protocol” may refer to a network protocol that is most commonly used in TCP/IP networks for submitting print jobs to a remote printer. An LPR client sends a print request to an IP address of a Line Printer Daemon (LPD) printer/server through an LPR gateway, where the LPD printer/server queues the file and prints it when the printer becomes available. The LPR protocol allows multiple print queues at the remote print server for receiving and managing print jobs from multiple client devices.

A ‘print job’ may refer to a request for printing a data file.

A ‘token’ may refer to a one-dimensional array for storing one or more particulars about the print job. The token includes at least one of: a first field for storing corresponding first name, a second field for storing corresponding print queue name, a first flag field for storing an enable status of the printer gateway at the print server, a second flag field for storing an enable status of corresponding print queue at the print server, and a timestamp field for storing a time of submission of corresponding stored job to the print server.

A ‘ready list’ may refer to a queue of all the newly generated tokens, for submission to the print server.

A ‘suspended list’ may refer to a queue of the tokens which could not be submitted successfully to the print server.

A ‘print spooling directory’ may refer to a storage space for temporarily storing print jobs prior to their submission to a print server.

A ‘print server’ may refer to a remote device that includes one or more printers for processing print job requests submitted by the client devices.

A ‘print queue’ may refer to a virtual printer with unique characteristics defined when the queue is created. At the print server, multiple queues are created and enabled to receive print job requests to help manage the flow of jobs through the print server.

A ‘printer gateway’ may refer to an LPR gateway for managing print job submissions from the client devices to the print server.

A ‘print gateway controller’ may refer to an LPR gateway service provided and managed by the print server.

A ‘first priority check’ may refer to a check performed for a token of a ready list to check if the printer gateway is enabled at the print server.

A ‘second priority check’ may refer to a check performed for a token of a ready list to check if a corresponding queue is enabled when the printer gateway is enabled at the print server.

A ‘third priority check’ may refer to a check performed for a token of a suspended list to check if a corresponding queue is enabled, the printer gateway is enabled at the print server, and a valid timestamp is recorded in corresponding timestamp field.

### Overview

In most existing print servers and gateways, job submissions fail and the jobs are deleted from a print spooling directory without completion, if a print queue specified in a print job is not enabled at the print server, or if the printer gateway is not enabled at the print server, or if there is a FIFO failure, etc. Thus, due to such premature deletion of job from the print spooling directory, the user may have to re-submit the print job, which is quite time consuming and cumbersome for them.

The disclosure generally relates to methods and systems for scheduling print jobs received at a printer gateway for submission to a print server. A print job is submitted to the print server only when both the printer gateway is enabled at the print server and a corresponding print queue is enabled at the print server. A print job is scheduled for a later submission/re-submission when either the printer gateway is not enabled or the corresponding print queue is not enabled, or the job submission fails even when the printer gateway and print queue are enabled. The key difference of the present disclosure from existing approaches is that the customer valuable data (jobs) are preserved and are not deleted from the print spooling directory until they are submitted successfully to the print server. Further, the job submission failure rate is considerably reduced, as the print jobs are submitted only when the printer gateway and corresponding print queue are enabled at the print server. Also, the user can run the scripts to submit a group of jobs using the printer gateway without having a fear of losing or resubmitting them.

### EXEMPLARY EMBODIMENTS

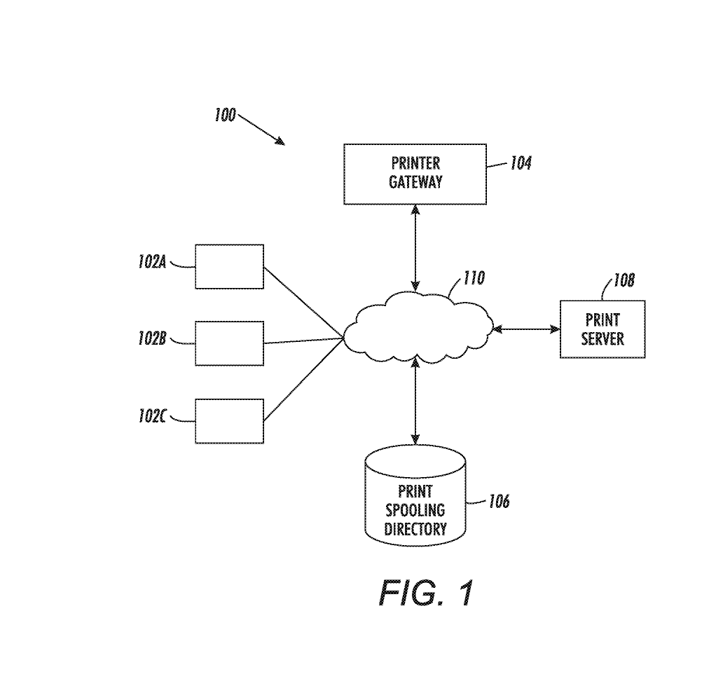

FIG. 1 is a block diagram illustrating a system environment 100, in which various disclosed embodiments can be practiced.

The system environment 100 includes first through third client devices 102a, 102b and 102c, hereinafter referred to as client devices 102, a printer gateway 104, a print spooling directory 106, and a print server 108.

The client devices 102, the printer gateway 104, the print spooling directory 106, and the print server 108 are communicatively coupled to each other via a communication network 110. Examples of the communication network 110 include wired or wireless network, such as but not limited to, a Local Area Network (LAN), a Wide Area Network (WAN), a Wi-Fi network and so forth.

The client device 102 refers to a computing device used by a user for submitting one or more print job requests to the print server 108 over the communication network 110. The client device 102 may include a variety of computing devices, such as a personal computer, a laptop, a mobile phone, tablet, PDA, a smart-phone or any other device capable of data communication. It will be apparent to a person skilled in the art that further client devices 102 may be added to the system 100, without limiting the scope of the disclosure.

The print server 108 may refer to a remote device that includes one or more printers for processing print job requests submitted by the client devices 102. At the print server 108, multiple queues are created and enabled to receive print job requests to help manage the flow of jobs through the print server 108. Each queue is like a virtual printer with unique characteristics defined when the queue is created. For example, a first queue may be created for receiving and queuing print requests on A3 paper, a second queue may be created for receiving and queuing print requests on A4 paper, a third queue may be created for receiving and queuing print requests on both sides of paper, and so on.

In an embodiment, each client device 102 executes an application of the print server 108 to display a GUI of the print server 108. The GUI may include a print manager for enabling a client device 102, such as the first client device 102a to submit a data file to be printed, specify a number of copies to be printed, a quality of print, size of paper, and a print queue, and the like. The GUI may further include a queue manager window to display all queues available on the print server 108. The queue manager may further display a name, priority, job acceptance, and release status of each queue available on the print server 108.

In an embodiment, the print jobs requested by the client devices 102 are received by the printer gateway 104, for submission to the print server 108. The printer gateway 104 may be either a standalone server or a service, or a combination of both, that is configured to schedule the print job requests so as to minimize job submission failure at the print server 108. In an example, each client device 102 is a Line Print Remote (LPR) client, the printer gateway 104 is an LPR gateway, and the print server 108 is an LPD server. Each client device 102 sends one or more print job requests to the print server 108 through the printer gateway 104 using an LPR command. In an example, the LPR command is represented as LPR -S “<IPAddress>” -P “<QueueName>” JobName, where IPAddress is an IP address of the print server 108, a queue name is name of print queue to which the print job is to be submitted at the print server 108, and job name is name of the requested print job.

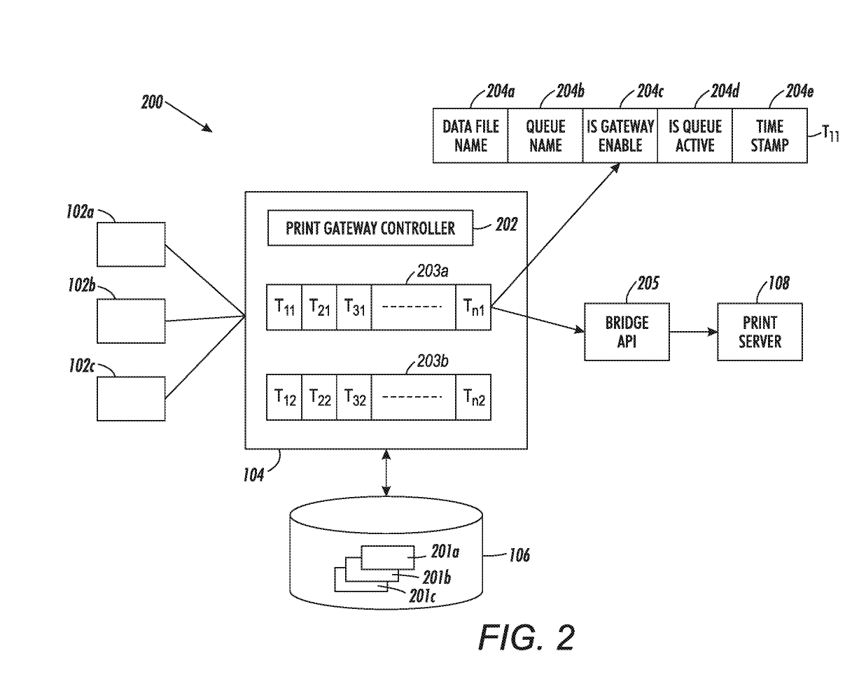

Upon receiving the LPR command from a client device 102 such as the first client device 102a, the printer gateway 104 separates the control file and data file from the received file, and save the control and data files in the print spooling directory 106. The data file includes the data content to be printed at the print server 108, and the control file includes various control parameters such as number of copies to be printed, name of the file, size, name of print queue to which job is to be submitted at the print server 108, quality of print, size of paper, etc. The print spooling directory 106 is a either a storage space or a storage server, that is configured to temporarily store print jobs prior to submission to the print server 108. In an embodiment, the data and control files are saved in the print spooling directory 106 with related names. For example if a name of a data file of a print job is saved as “YYYY,” then a name of corresponding control file is saved as “ctrl_YYYY.” The scheduling of print job requests at the printer gateway 104 for submission to the print server 108 is further explained with reference to FIG. 2.

FIG. 2 is a block diagram illustrating a system 200 for scheduling one or more print jobs received at the printer gateway 104, in accordance with an embodiment.

The system 200 includes the print spooling directory 106 that is configured to temporarily store first, second and third print job requests 201a, 201b, and 201c, hereinafter collectively referred to as print job requests 201, received at the printer gateway 104, from the client devices 102. The system 200 further includes a print gateway controller 202, which is, for example, an LPR gateway service provided and managed by the print server 108.

During the start-up of the print server 108, the print gateway controller 202 checks if the print spooling directory 106 includes any print job requests. When the print spooling directory 106 stores one or more print job requests, the print gateway controller 202 generates tokens corresponding to the stored jobs. For example, the print gateway controller 202 generates first, second and third tokens T₁₁, T₂₁ and T₃₁ corresponding to the first, second and third stored jobs 201a, 201b, and 201c.

The print gateway controller 202 maintains a first list 203a, hereinafter also referred to as a ready list 203a, and adds all the newly generated tokens such as the first, second and third tokens T₁₁, T₂₁ and T₃₁ to the ready list 203a. The first, second and third tokens T₁₁, T₂₁ and T₃₁ in the ready list 203a are ready for submission to the print server 108 through a bridge API 205. The bridge API 205 is a group of interfaces that allow a non-Free Flow Print Server (FFPS) component to communicate to FFPS including job submission.

The print gateway controller 202 further maintains a second list 203b, hereinafter also referred to as a suspended list 203b and moves one or more tokens from the ready list 203a to the suspended list 203b in case of submission failure. In an embodiment, the first and second lists 203a and 203b are queues, in which tokens are added and removed in a sequential manner.

The print gateway controller 202 populates the first, second and third tokens T₁₁, T_{21 . . .} Tₙ₁ with one or more particulars of corresponding print jobs 201. Each token of the ready and suspended lists 203a and 203b includes total five fields. For example, the first token T₁₁ includes a first field 204a for storing a data file name of the first print job 201a, a second field 204b for storing a queue name of the first print job 201a, a third field 204c for storing a first flag ‘Is gateway enabled’ for indicating an enable status of the printer gateway 104 at the print server 108, a fourth field 204d for storing a second flag ‘Is queue enabled’ for indicating an enable status of corresponding print queue at the print server 108, and a fifth field 204e for indicating a time of submission of the first print job 201a to the print server 108.

In an embodiment, the print gateway controller 202 stores a default queue name in the second field 204b, if a queue name is not specified in the LPR command of the first print job 201a. In another embodiment, the print gateway controller 202 initially assigns default value ‘false’ to the third and fourth fields 204c and 204d respectively. In yet another embodiment, the print gateway controller 202 initially assigns default value ‘0’ to the fifth field 204e.

When the first flag 204c ‘Is gateway enabled’ is set to false, it implies that the printer gateway 104 is not enabled at the print server 108, and vice versa. Similarly, when the second flag 204d ‘Is queue enabled’ is set to false, it implies that corresponding print queue is not enabled at the print server 108 and is not in a mode to accept the print jobs, and vice versa. It may be noted that in gateways using the LPD tab, the administrator/user may enable or disable the LPD protocol, set the default queue, and set the LPD port.

The print gateway controller 202 schedules the tokens in the ready list 203a for submission to the print server 108 based on three priority checks. For example, in first priority check for the first token T₁₁, the print gateway controller 202 checks whether the printer gateway 104 is enabled at the print server 102. If the printer gateway 104 is not enabled, it sets the first flag 204c ‘Is gateway enabled’ to false, and moves the first token T₁₁ to the second list 203b. When the printer gateway 104 is enabled at the print server 108, the print gateway controller 202 sets the first flag 204c ‘Is gateway enabled’ to true, and moves the token T₁₁ to the first list 203a for re-submission of job 201a to the print server 108.

In the second priority check, the print gateway controller 202 checks a status of a queue specified in the second field 204b. If the corresponding queue is not enabled at the print server 108, i.e., the queue is not in a mode to accept the jobs, then the print gateway controller 202 sets the second flag 204d “Is queue enabled” to false, and moves the first token T₁₁ to the second list 203b. When the corresponding queue is enabled, the print gateway controller 202 sets the second flag 204d “Is queue enabled” to true, and moves the token T₁₁ to the ready list 203a for re-submission of the print job 201a to the print server 108.

In an embodiment, the print gateway controller 202 deletes the first print job 201a from the print spooling directory 106, and also the first token T₁₁ from the ready list 203a, when the first print job 201a is submitted and completed successfully. In an embodiment, all the tokens are deleted from the first and second lists 203a and 203b when the print server 108 is turned off.

In another embodiment, when the submission of the first print job 201a fails due to partial transfer of data or due to any other reason, the print gateway controller 202 records a timestamp of submission of the first print job 201 in the fifth field 204e, and moves the first token T₁₁ to the second list 203b. The print gateway controller 202 then performs a third priority check for the first token T₁₁ of the second list 203b. In the third priority check, the print gateway controller 202 checks the first and second flags 204c and 204d of the first token T₁₁ at regular intervals, and re-submits the first print job 201 to the print server 108 after an expiry of the predefined period. In an example, a routine may keep on checking the first and second flag values of tokens in the suspended list 203b, and move those tokens back to the ready list 203a in which corresponding second and third flags 204c “Is gateway enabled” and 204d “Is queue enabled” are set to true, and the fifth field 204e includes a valid timestamp. Such tokens may be added to the ready list 203a after expiry of few minutes, for example two minutes, from a previous submission.

In an embodiment, enabling of the printer gateway 104 at the print server 108 is a user configurable setting in the GUI (of the print server 108), executing on the client devices 102. When the user enables the printer gateway 104 through their GUI, an event may be notified to the print gateway controller 202, which may in turn update the first flag 204a ‘Is gateway enabled’ of one or more tokens of the suspended list 203b from ‘false’ to ‘true’, and move the updated tokens to the ready list 203a, so that they may be submitted to the print server 108. In an example, upon receiving the notification, a routine may go through the suspended list 203b for updating the “is Gateway Enabled” flag for such tokens from ‘false’ to ‘true’, and move the updated tokens to the ready list 203a for submission/resubmission.

In another embodiment, enabling a queue of the print server 108 is a user configurable setting in the GUI (of the print server 108), executing on the client devices 102. When the user enables a queue through their GUI, an event may be notified to the print gateway controller 202, which may in turn find the tokens of the suspended list 203b that stores the queue name in corresponding second field, update the second flag ‘Is queue enabled’ of such tokens from ‘false’ to ‘true’, and move the updated tokens to the ready list 203a, so that they may be submitted to the print server 108. In an example, when a user enables a queue of name ‘xxxx’ through the GUI, a notification may be sent to the print gateway controller 202. Upon receiving the notification, the print gateway controller 202 may execute a routine to go through the suspended list 203b to find the tokens containing queue name ‘xxxx’ in corresponding second field, and update the “is Queue Enabled” flag for such tokens from ‘false’ to ‘true’, and move the updated tokens to the ready list 203a for submission/resubmission.

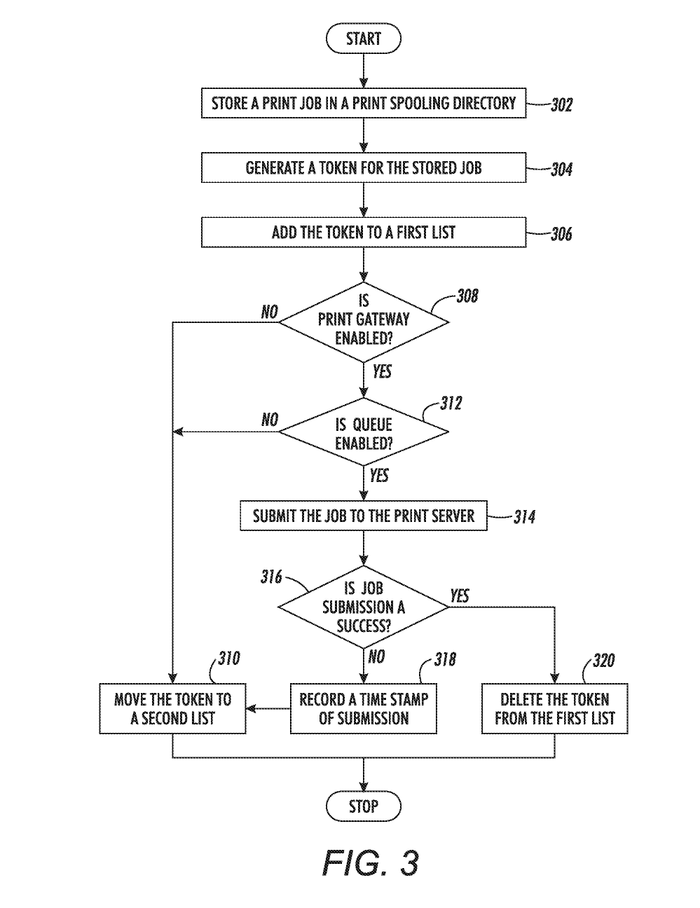

FIG. 3 is a flowchart illustrating a method for scheduling a print job received at a printer gateway, in accordance with an embodiment.

At 302, a print job is stored in a print spooling directory. In an embodiment, a data and a control file of the print job are saved in the print spooling directory with related names. For example if a name of a data file of a print job is saved as “YYYY,” then a name of corresponding control file is saved as “ctrl_YYYY.”

At 304, a token is generated for the stored job. The token includes at least one of: a first field for storing corresponding data file name, a second field for storing corresponding print queue name, a first flag field for storing an enable status of the printer gateway at the print server, a second flag field for storing an enable status of corresponding print queue at the print server, and a timestamp field for storing a time of submission of corresponding stored job to the print server.

At 306, the token is added to a first list, herein after also referred to as a ready list. All the newly generated tokens are added to the first list, for submission to the print server.

At 308, it is checked if the printer gateway is enabled at the print server. In an embodiment, enabling of the printer gateway at the print server is a user configurable setting in the GUI (of the print server). When the user enables the printer gateway through their GUI, an event may be notified to the print gateway controller.

At 310, the token is moved from the first to the second list, when the printer gateway is not enabled at the print server. In an embodiment, when the printer gateway is not enabled, the flag ‘Is gateway enabled’ in corresponding token is set to false, and the token is moved to the second list for later submission/re-submission of the print job.

At 312, it is checked if a corresponding print queue of token is enabled at the print server, when the printer gateway is enabled at the print server. In an embodiment, enabling a queue of the print server is a user configurable setting in the GUI of the print server. When the user enables a queue through their GUI, an event may be notified to the print gateway controller. When the corresponding print queue is not enabled at the print server, step 310 is repeated.

At 314, the print job is submitted to the print server if the corresponding print queue is enabled at the print server. Thus, the print job is submitted to the print server if both the print queue and printer gateway are enabled at the print server.

At 316, it is checked if submission of the print job is a success. The submission of the print job is a success when it is completely transferred to the print server, and the print job is completed.

At 318, a timestamp of submission is recorded, when the print job submission fails, and step 310 is repeated. In an embodiment, the first and second flags of corresponding token of the second list are checked at regular intervals, and the print job is resubmitted after an expiry of the predefined period when both the first and second flags are set to true.

At 320, the token is deleted from the first list when the print job is submitted successfully. In an embodiment, corresponding print job is deleted from the print spooling directory, and corresponding token is deleted from the first list, when the print job is submitted and completed successfully.

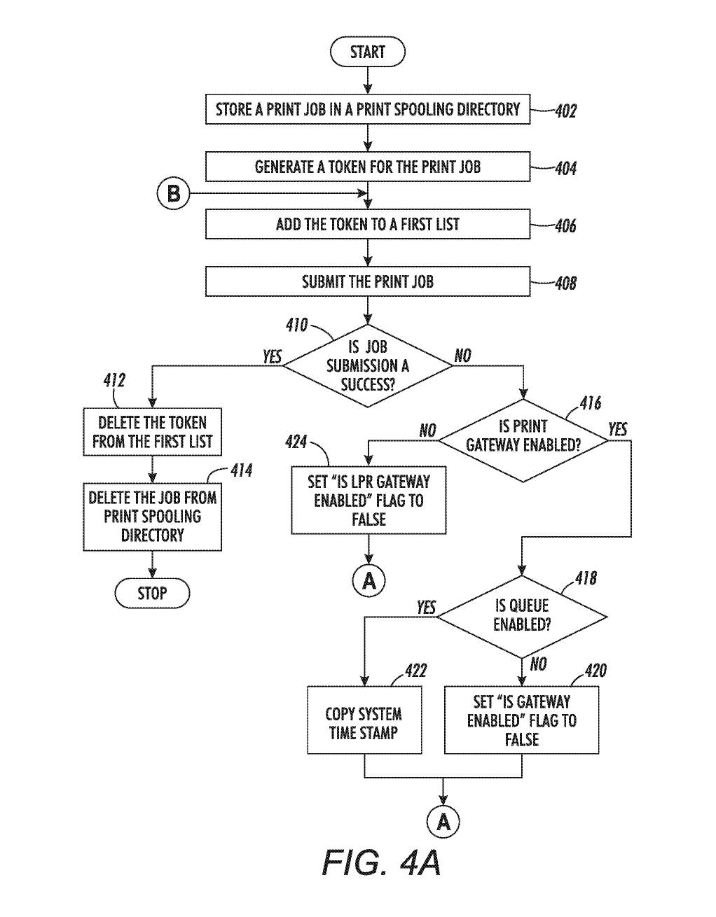

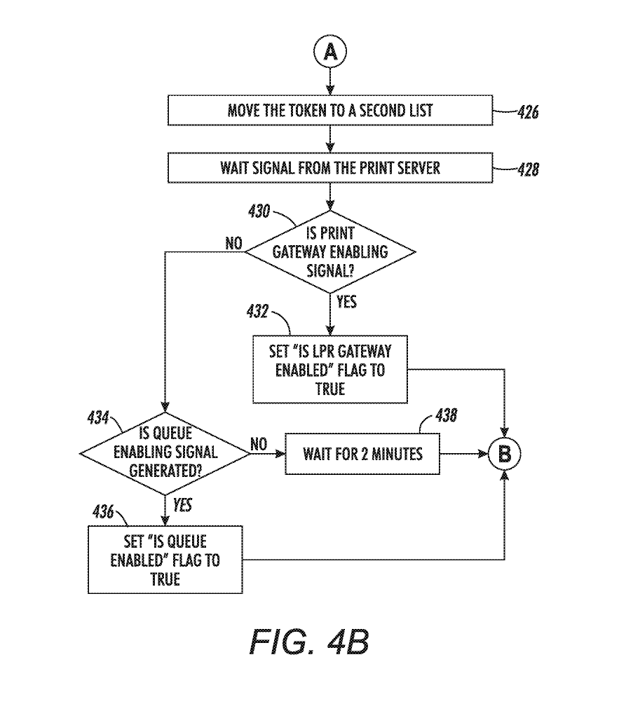

FIGS. 4A and 4B are flowcharts illustrating a detailed method for scheduling a print job received at the printer gateway, in accordance with an embodiment.

At 402, a print job is stored in a print spooling directory. At 404, a token is generated for the print job. At 406, the token is added to a first list. At 408, the print job corresponding to the token is submitted to the print server.

At 410, it is checked if the job submission is a success. If the job submission is a success, then at 412, the token is deleted from the first list, and at 414, the job is deleted from the print spooling directory.

If the job submission is a failure, it is tried to find the reason for the job submission failure. As part of that at 416, it is checked if the printer gateway is enabled. If the printer gateway is enabled then at 418, it is checked if a corresponding queue is enabled. If the queue is not enabled, then at 420, “Is queue enabled’ flag is set to false and at 426, the token is moved to a second list. If the printer gateway is not enabled then at 424, “Is gateway enabled” flag is set to false and at 426, the token is moved to a second list. If the queue is enabled, then at 422, system time-stamp is copied and at 426, the token is moved to a second list.

As part of resubmission process of jobs that are failed and added to the second list, at 428, a signal from the print server is awaited. On receiving the signal at 430, it is checked, if the printer gateway enabling signal is generated. If the print gateway enabling signal is generated, then at 432, “Is gateway enabled” flag is set to true and method goes back to step 406. If the print gateway enabling signal is not generated, it is checked at 434, if the queue enabling signal is generated. If the queue enabling signal is generated, then at 436, “Is Queue enabled” flag is set to true and method goes back to step 406. Alternatively, at 438, method goes back to step 406 after waiting for two minutes in case of no valid signal.

The order in which the method is described is not intended to be construed as a limitation, and any number of the described method blocks can be combined in any order to implement the method or alternate methods. Additionally, individual blocks may be deleted from the method without departing from the spirit and scope of the subject matter described herein. Furthermore, the method can be implemented in any suitable hardware, software, firmware, or combination thereof. However, for ease of explanation, in the embodiments described below, the method may be considered to be implemented in the above described system and/or the apparatus and/or any electronic device (not shown).

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

Note that throughout the following discussion, numerous references may be made regarding servers, services, engines, modules, interfaces, portals, platforms, or other systems formed from computing devices. It should be appreciated that the use of such terms are deemed to represent one or more computing devices having at least one processor configured to or programmed to execute software instructions stored on a computer readable tangible, non-transitory medium or also referred to as a processor-readable medium. For example, a server can include one or more computers operating as a web server, database server, or other type of computer server in a manner to fulfill described roles, responsibilities, or functions. Within the context of this document, the disclosed devices or systems are also deemed to comprise computing devices having a processor and a non-transitory memory storing instructions executable by the processor that cause the device to control, manage, or otherwise manipulate the features of the devices or systems.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “generating,” or “monitoring,” or “displaying,” or “tracking,” or “identifying,” “or receiving,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The terminology used herein is for the purpose of describing particular embodiments only and is not intended to be limiting of the disclosure. It will be appreciated that several of the above-disclosed and other features and functions, or alternatives thereof, may be combined into other systems or applications. Various presently unforeseen or unanticipated alternatives, modifications, variations, or improvements therein may subsequently be made by those skilled in the art without departing from the scope of the present disclosure as encompassed by the following claims.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. A method for scheduling one or more print jobs at a printer gateway in a real-time, for submission to a print server, the method comprising:
storing a print job received from a client device, in a print spooling directory, the client device executing an application of the print server to display a Graphical User Interface (GUI) of the print server;
generating a token corresponding to the stored job, the token comprising one or more particulars of the stored job;
adding the token to a first list at the printer gateway;
checking if the printer gateway is enabled at the print server;
moving the token from the first list to a second list at the printer gateway, when the printer gateway is not enabled at the print server;
checking if a print queue specified in the token of the first list is enabled at the print server;
moving the token from the first list to the second list, when corresponding print queue is not enabled at the print server; and
submitting corresponding stored job to the print server, when corresponding print queue is enabled at the print server.

2. The method as claimed in claim 1, wherein the print job includes a data file that is saved with a first name, and a control file that is saved with a second name related to the first name.

3. The method as claimed in claim 2, wherein the token includes at least one of: a first field for storing corresponding first name, a second field for storing corresponding print queue name, a first flag field for storing an enable status of the printer gateway at the print server, a second flag field for storing an enable status of corresponding print queue at the print server, and a timestamp field for storing a time of submission of corresponding stored job to the print server.

4. The method as claimed in claim 3, further comprising:
recording a timestamp of submission of the stored job when the submission of the stored job fails;
moving the token from the first list to the second list when the submission of the stored job fails; and
resubmitting corresponding stored job to the print server after an expiry of a predefined period.

5. The method as claimed in claim 3, further comprising:
receiving a notification at the printer gateway, from the print server, when corresponding printer gateway is enabled at the print server;
updating the first flag field of one or more tokens of the second list based on the notification; and
moving the updated one or more tokens from the second list to the first list.

6. The method as claimed in claim 3, further comprising:
receiving a notification at the printer gateway, from the print server, when a print queue is enabled at the print server;
updating the second flag field of one or more tokens of the second list based on the notification; and
moving the updated one or more tokens from the second list to the first list.

7. The method as claimed in claim 1, further comprising deleting the stored job from the print spooling directory and deleting corresponding token from the first list, when the submission of the stored job succeeds.

8. The method as claimed in claim 1, further comprising assigning a default print queue to the token, when a print queue is not specified in corresponding stored job.

9. A system for scheduling one or more print jobs at a printer gateway for submission to a print server, the system comprising:
a print spooling directory to store a print job received from a client device; and
a print gateway controller to:
generate a token corresponding to the stored job;
add the token to a first list at the printer gateway;
move the token from the first list to a second list at the printer gateway, when the printer gateway is not enabled at the print server;
check if a print queue specified in the token is enabled at the print server, when the printer gateway is enabled;
move the token from the first list to the second list when corresponding print queue is not enabled at the print server; and
submit the stored job to the print server, when corresponding print queue is enabled at the print server.

10. The system as claimed in claim 9, wherein the print gateway controller is to save a data file of the print job with a first name, and a control file of the print job with a second name related to the first name.

11. The system as claimed in claim 10, wherein the token includes at least one of: a first field for storing corresponding first name, a second field for storing corresponding print queue name, a first flag field for storing an enable status of the printer gateway at the print server, a second flag field for storing an enable status of corresponding print queue at the print server, and a timestamp field for storing a time of submission of corresponding stored job to the print server.

12. The system as claimed in claim 11, wherein the print gateway controller is to:
record a timestamp of submission of the stored job, when the submission of the stored job fails;
move the token from the first list to the second list when corresponding submission fails; and
resubmit the stored job to the print server after an expiry of a predefined period.

13. The system as claimed in claim 11, wherein the print gateway controller is to:
receive a notification from the print server, when corresponding printer gateway is enabled at the print server;
update the first flag field of one or more tokens of the second list based on the notification; and
move the updated one or more tokens from the second list to the first list.

14. The system as claimed in claim 11, wherein the print gateway controller is to:
receive a notification at the printer gateway, when a print queue is enabled at the print server;
update the second flag field of one or more tokens of the second list based on the notification; and
move the updated one or more tokens from the second list to the first list.

15. The system as claimed in claim 9, wherein the print gateway controller is to delete the stored job from the print spooling directory and delete corresponding token from the first list, when the submission of the stored job succeeds.

16. The system as claimed in claim 9, wherein the print gateway controller is to assign a default print queue to the token, when a print queue is not specified in corresponding stored job.

17. A non-transitory computer-readable medium storing computer-readable instructions that when executed by a print gateway controller of a system for scheduling one or more print jobs, the non-transitory computer-readable medium comprising instructions for:
storing a print job received from a client device, in a print spooling directory;
generating a token corresponding to the stored job, the token comprising one or more particulars of the stored job;
adding the token to a first list at the printer gateway;
checking if the printer gateway is enabled at the print server;
moving the token from the first list to a second list, when the printer gateway is not enabled at the print server;
checking if a print queue specified in the token of the first list is enabled at the print server;
moving the token from the first list to the second list when corresponding print queue is not enabled at the print server; and
submitting corresponding stored job to the print server, when corresponding print queue is enabled at the print server.

18. The non-transitory computer-readable medium as claimed in claim 17, wherein the token includes at least one of: a first field for storing corresponding first name, a second field for storing corresponding print queue name, a first flag field for storing an enable status of the printer gateway at the print server, a second flag field for storing an enable status of corresponding print queue at the print server, and a timestamp field for storing a time of submission of corresponding stored job to the print server.

19. The non-transitory computer-readable medium as claimed in claim 18, wherein the print gateway controller is further instructed to perform:
recording a timestamp of submission of the stored job in corresponding timestamp field, when the submission fails;
moving the token to the second list; and
resubmitting the stored job to the print server after an expiry of a predefined period.

20. The non-transitory computer-readable medium as claimed in claim 18, wherein the print gateway controller is further instructed to perform:
receiving a notification at the printer gateway, from the print server, when corresponding printer gateway is enabled at the print server;
updating the first flag field of one or more tokens of the second list based on the notification; and
moving the updated one or more tokens to the first list.

21. The non-transitory computer-readable medium as claimed in claim 18, wherein the print gateway controller is further instructed to perform:
receiving a notification at the printer gateway, from the print server, when a print queue is enabled at the print server;
updating the second flag field of one or more tokens of the second list based on the notification; and
moving the updated one or more tokens to the first list.
